(19) United States
(12) Patent Application Publication
(10) Pub. No.: US 2007/0131822 A1
(43) Pub. Date: Jun. 14, 2007

(54) Aerial and ground robotic system

(75) Inventor: Kevin Leigh Taylor Stallard, Palisade, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Kevin Leigh Taylor Stallard

(21) Appl. No.: 11/471,387

(22) Filed: Jun. 20, 2006

Related U.S. Application Data
(60) Provisional application No. 60/692,305, filed on Jun. 20, 2005.

(51) Int. Cl. B64C 13/20

(52) U.S. Cl. 244/190

(57) ABSTRACT

An aerial and ground robotic system has a number of mobile nodes creating a mesh network, including at least one aerial node. A sensor is provided on the at least one aerial node. A base station receives data from the sensor through the mesh network.

### RELATED APPLICATIONS

The present invention claims priority on provisional patent application, Ser. No. 60/692,305, filed on Jun. 20, 2005, entitled “Unmanned Aerial and Ground Robotic System” and is hereby incorporated by reference.

### FIELD OF THE INVENTION

The present invention relates generally to the field of unmanned systems and more particularly to an aerial and ground robotic system.

### BACKGROUND OF THE INVENTION

In most modern unmanned aerial vehicle systems and ground robotic systems, the unmanned aerial vehicle carries one or more computing platforms. These platforms have been developed to solve a very narrow range of problems, mostly safe flight and navigation. They contain enough functionality for a base station to control them. They also may have functionality that will allow them to follow “waypoints” this allows them to return autonomously to land.

The communication between these systems is well defined and narrow. Flexibility is not considered as the costs of doing so and validating this flexibility is high. The operating systems used in present unmanned aerial vehicles cannot handle a more flexible communication system.

As a result, these unmanned aerial and ground based robotic systems only perform a very narrow range of missions.

Thus there exists a need for an unmanned aerial vehicle and ground robotic system that is flexible and can be used for a variety of missions.

### SUMMARY OF THE INVENTION

The present invention is directed to an unmanned aerial and ground robotic system that is capable of tackling a number of different mission. This is made possible by having a number of nodes that form a mesh network. Each node can be both a communication/control node and a sensor or tool carrier. The system has a base station with mission planning software that assigns initial tasks and goals for the each of the nodes. Every node uses a real time operating system and a transparent networking substrate for communication. The nodes create a mesh communication and control network to fit the specific mission. As a result, the network can expand to hundreds of square miles or can be as small as a city block depending on the needs of the mission. Every sensor and resource can be accessed by any other node and the information is relayed by intermediate nodes. Thus, this provides an incredibly flexible unmanned aerial vehicle and ground based robot system.

### BRIEF DESCRIPTION OF THE DRAWINGS

FIG. 1 is a schematic view of an aerial and ground robotic system in accordance with one embodiment of the invention;

FIG. 2 is a block diagram of an aerial and ground robotic system in accordance with one embodiment of the invention;

FIG. 3 is a block diagram of a node in an aerial and ground robotic system in accordance with one embodiment of the invention; and

FIG. 4 is a block diagram of a base station in an aerial and ground robotic system in accordance with one embodiment of the invention.

### DETAILED DESCRIPTION OF THE DRAWINGS

The present invention is directed to an unmanned aerial vehicle and ground robotic system that is flexible enough to handle a number of different assignments. The system has a number of nodes that may include unmanned aerial vehicles and ground robots to form a mesh network that provides a communication and control network. The mesh network is self configuring which allows the system to expand or alter to fit a mission whether it covers hundreds/thousands of square miles or whether the mission covers just a city block. The mesh network allows each node access to any other nodes resources.

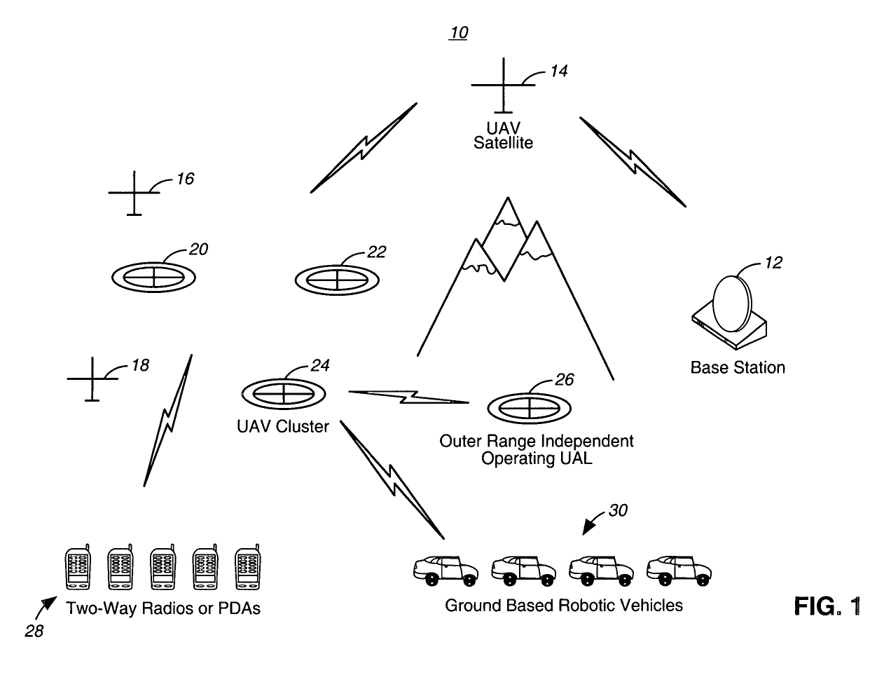

FIG. 1 is a schematic view of an aerial and ground robotic system 10 in accordance with one embodiment of the invention. The system 10 has a base station 12. The base station 12 is in communication with an unmanned aerial vehicle (UAV) 14. This UAV 14 may be a high altitude UAV that is mainly acting as a communication/control relay. Other UAV's 16, 18 may also be used in this function in supporting the mesh network. A number of lower altitude UAVs 20, 22, 24, 26 also form nodes of the mesh network. However, these lower altitude UAVs 20, 22, 24, 26 may perform other functions such as providing sensor data. For instance, a low altitude UAV may be equipped with a FLIR (Forward Looking InfraRed sensor). This may be used to find a person lost in the woods or to find hot spots in a forest fire. This sensor data is transmitted through the mesh network back to the base station 12. The base station 12 is also in communication with a number of two way radios and PDAs (Personal Digital Assistants) 28. The mesh network can also allow these two way radios/PDAs to communicate with each other when they are not within line-of-sight. A number of ground based robots 30 are also coupled to the mesh network.

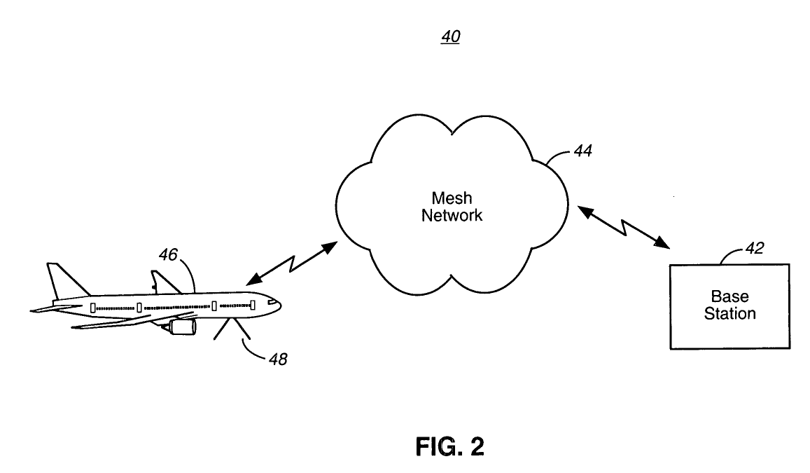

FIG. 2 is a block diagram of an aerial and ground robotic system 40 in accordance with one embodiment of the invention. The system 40 in its easiest to conceptualize form has a base station 42 coupled to a mesh network 44. The mesh network 44 is coupled to an unmanned aerial vehicle (UAV) 46. The UAV 46 has a sensor 48 and the output of the sensor 48 is transmitted back to the base station 42. The base station 42 can also control the flight path of the UAV 46 or the UAV can be set to scan a region. Note however in a real system 40 the UAV 46 may be a node in the mesh network as is the base station 42. In addition, the nodes of the mesh network may include other robots that perform other functions including scanning other areas, providing supplies to firefighters, etc.

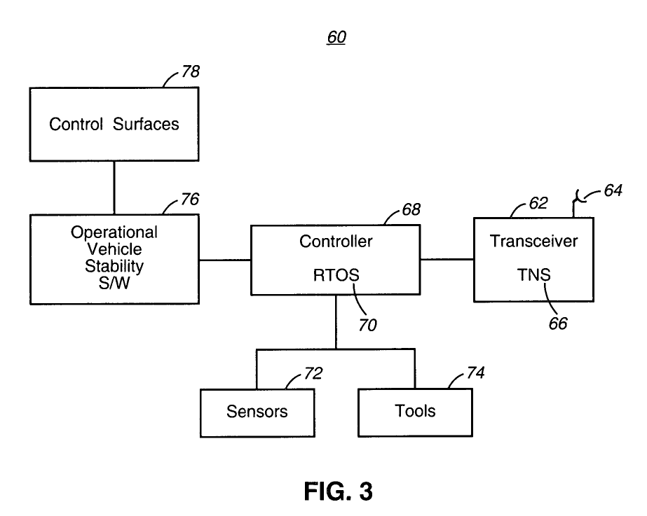

FIG. 3 is a block diagram of a node in an aerial and ground robotic system 60 in accordance with one embodiment of the invention. The system 60 has a transceiver 62 or multiple transceivers coupled to an antenna 64. The transceiver 62 uses a transport networking substrate (TNS) 66. The TNS 66 uses less bandwidth than other networking protocols, combines multiple packets into one packet to conserve bandwidth, establishes communications between the various nodes of the mesh network, allows monitoring and control of every software module on the platform, has quality of service functionality and can be used with all communication devices. The transceiver 62 is coupled to one or more controllers 68. The controller 68 uses a real-time operating system (RTOS) 70. The RTOS allows precise control and guarantees critical software will execute when needed. The RTOS also provides consistent and uniform access to the hardware on the nodes or platform and allows for parallel (or pseudo parallel) execution of different software modules. The controller is coupled to sensors 72 and tools 74. The sensors 72 may include video, infrared, metrological sensors, etc. The tools 74 may include the ability to drop water and supplies, mechanical arms, etc. The controller 68 is also coupled to an operational vehicle stability software 76. This software is used on mobile/roaming vehicles. The software 76 reads various sensors and move actuators/engines 78 to keep the vehicle on its designated course. In addition, this software allows for manual control of the vehicle. Each node will have at least some subset of the functionality shown in FIG. 3. For instances, handheld radios will not have sensors 72, tools 74, the software 76 or control surfaces 78.

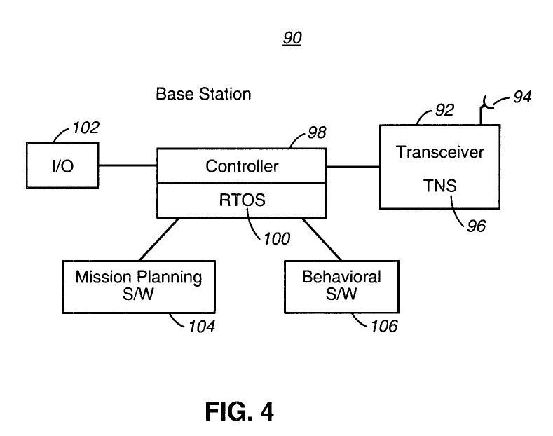

FIG. 4 is a block diagram of a base station in an aerial and ground robotic system 90 in accordance with one embodiment of the invention. The base station 90 has a transceiver(s) 92 coupled to an antenna 94. The transceiver 92 also uses the transport networking substrate (TNS) 96. The transceiver 92 is coupled to a controller(s) 98 that uses a real time operating system (RTOS) 100. The Controller 98 is coupled to a number of input/output devices 102 including storage devices. The controller 98 is also coupled to mission planning software 104 that allows mission planners to allocate nodes or resources geographically and to view the present location of nodes on a map. The mission planning software 104 allows planners to specify target information, for instance in firefighting situation they may be looking for hot spots. The mission planning software also allows planners to view the decisions made by the airborne and ground based vehicles and to modify these decisions. Finally, the software 104 allows planners to view acquired targets and their location. The controller 98 is also coupled to behavioral software 106. The behavioral software 106 interprets the mission and changes the behavior of the individual nodes based on its capabilities and requirements of the mission. For instance, if a high flying UAV spots a warm spot in a search for lost person using an infrared sensor, a more mobile lower flying UAV with a video camera may be directed to investigate the hot spot in more detail.

Scenario

Below is a fictional example that illustrates the versatility of the present system.

On January 9^{th}, Dan, Debra, and Camille Walker and their dog went cross country skiing on top of the Grand Mesa in the Grand Mesa National forest near Grand Junction, Colo. The Grand Mesa is a flat top mountain with an average altitude of 10,000 feet. It has areas of very dense trees and has numerous hills and shallow valleys. It is also spotted with numerous small lakes and reservoirs. The week of January 9^{th} saw a number of winter storms come through the area, visibility on the Grand Mesa as very limited. Flying conditions were dangerous for manned airborne vehicles.

The family left their other daughter, Elyse, behind at home. She didn't want to go. They indicated to her that they would be back around 4 pm that evening (the evening of the 9^{th}). They never came home. Around 8 pm that evening Elyse called the authorities, 10 minutes later, we received a phone call from Sheriff Stan Hilkey asking us to assist. The weather conditions were too dangerous for a helicopter. Besides, considering the area they had to cover, they weren't sure it could do much more than ferry searchers to and from the search site any way.

Our unmanned aerial vehicle fleet includes (to help us identify them, we've given them names):
1. 4 Fixed wing, high endurance aircraft (Eagle1 through Eagle4)
2. 3 small enclosed rotor wing VTOL aircraft (Hummingbird1-Hummingbird3)
3. 2 medium sized exposed rotor wing VTOL aircraft (chopper1 & chopper2)

They are equipped with the following sensor packages:

1 Eagle 1 through Eagle 4 have:
a. 1 900 MHz Motorola Canopy Access point
b. 1 900 MHz low speed Freewave radio modem
c. 1 2.4 GHz Motorola Canopy Access Point
d. 2 5.7 GHz Motorola Canopy point to point backhaul units
e. 1 Motorola MEA mesh networking access point
f. FAA Approved Mode C Transponder
g. On board audio transceiver for VHF/UHF and 700/800 MHz two radio band
h. 10 mega pixel High resolution gimbaled CMOS camera w/zoom
i. $4,000 low resolution B&W FLIR Imager
j. JPEG2000 video hardware based compression/decompression system
k. RJ Direction finder for locating source of audio radio
i. 5 400 MHz Power PC based computing platforms
m. Obstacle avoidance radar
n. High power, long range directional infrared illuminator
o. High power halogen directional lamp

2 Chopper1 & Chopper2
a. 1 900 MHz Canopy Subscriber module
b. 1 2.4 GHz Motorola Canopy Subscriber module
c. 1 900 MHz low speed Freewave radio modem
d. 2 802.1 lb wireless Ethernet NIC in ad-hoe mode
e. 4 mega pixel gimbaled CMOS camera with zoom and removable IR filter
f. Chopper 1 has a $20,000 color hi-res FLIR imager with zoom capabilities
g. Chopper 2 has a $4,000 B&W low resolution FLIR imager
h. Chopper 2 has a $25,000 obstacle avoidance radar package.
i. LED flood light
j. Medium power, medium range infrared illuminator

3 Hummingbird 1, 2 & 3
a. 802.1 lb wireless Ethernet NIC in ad hoc mode
b. 900 Mhz radio modem
c. 4 mega pixel gimbaled CMOS camera, no zoom or sub $1000.00 thermal imager (not strong enough to carry both, outfitted before launch).
d. LED Visible Illumination or IR LED Illumination.

The Hummingbirds are attached to an airborne deployment system on our fixed wing aircraft. These devices are battery powered and are only used when we have to get into tight quarters.

Before I hung up the phone with Stan, I indicated that since the edge of the Grand Mesa was less than 15 miles from our office we would be running our operation from there and invited him and any of his mission planners to meet us. I also ask him to email me the coordinates of the search area.

7:15 pm—I place a call to our flight control officer and another of our UAV pilots and had them meet us at the office. After talking with them, I dial into our control center and activate the system.

7:35 pm—I'm the first one to arrive at the control center. I do preflight checks of our systems. They all have fuel and are ready to fly. I enter the control room and enter the coordinates of the search area into our mission planner.

I also check connectivity with the vehicles and make sure their video (both FLIR and Visual) systems are functioning. I also indicate to the planning software that we are looking for human forms and prioritize various heat and visual signature templates we have on file. It's night time and if these folks have holed themselves up in a snow cave, we should be able to see some evidence of it. So blobs of faint heat signatures are put up to the top of the alert list. Since we're looking for three people, I tell the system to ignore groups of four or more people.

It doesn't really matter that much, this prioritization is only used to give weight values to possible targets. All targets will eventually be reviewed, but putting what would most likely be the characteristics of what we're looking for on the top of the list, we can avoid running after wildlife.

The coordinates are in, and everything is ready to fly.

7:55 pm Tim (our flight control office) and Ron (UAV pilot) arrive. I sum up what I've done and Tim directs Ron to go ahead and launch the vehicles. I must say, this is my favorite part. Ron tunes and listens to ATIS, and then calls the Grand Junction Tower:

“Grand Junction tower, flight of six UAV with Golf, ready to depart 2 miles southeast the airport, east departure to the Grand Mesa. This is an urgent search and rescue operation request by the Mesa County Sheriffs department.”

“Flight of six UAV, this is Grand Junction tower. Departure approved, climb and maintain 5,500, direct to the river, then follow it east until you're outside my airspace. Squawk 3221, altimeter is 29.93.”

“Departure approved, climb and maintain 5,500, direct to the river, then east until outside class D. Squawking 3221, altimeter 29.93. Flight of six UAV.”

“Flight of six, Grand Junction Tower, roger, we're amending ATIS and we'll put a NOTAM to Flight Service for you. If the Tower is closed when you're done, please contact Flight Service on 122.6 to cancel the NOTOM and also Denver Center on 134.5 to cancel your flight. Good Luck.”

“Roger, we'll contact Flight Service and Denver when you're done, thanks, Flight of six.”

Ron enters the instructions into the mission planner, makes notes of the things Tower had asked him to do when the mission was done, and sets the Eagle's transponders to squawk 3221 and sets the system altimeter to the proper setting. He ‘clicks’ the big green ‘Go’ button and almost instantly all the Eagles and Choppers come to life. The engines warm up a bit and the systems do their final self tests. One by one, the fixed wings head out the open door and lift off, their navigation and collision avoidance lights flashing steadily in the night sky. Once the last of the fixed wings are gone, the Choppers rev their engines and the distinct sound of the blades taking the load when collective is applies in heard. They carefully make their way outside and then on to the river.

“Flight of six UAV, Grand Junction tower, radar contact is 2.5 miles southeast at 5,500. there is no traffic in the area.”

“Roger Tower, thanks, Flight of Six.”

During their departure, we check the video and monitor the communications link. Looks like we have a 50 Mega bit per second (Mbps) link with the vehicles. The video is streaming back fine. The Grand Valley really looks beautiful from up there at night. FLIR checks out too. We also test the Hummingbird systems, all looks good.

We sit back and wait for them to arrive over the search area.

8:30 pm—We got lost in conversation and realized that the vehicles had already set themselves up in a search pattern and were working the area. A number of possible ‘hits’ were already listed and on the map.

Eagle 1 had set himself in a five-mile holding pattern up on the rim of the Mesa. It was with this craft that we are able to communicate with the rest of the system. It is in effect extending our local area network (LAN) to itself and to the rest of the vehicles working the area. We have complete control of every system and piece of hardware on every vehicle., right down to the device drivers themselves. Likewise, every vehicle has complete access to any resource it might need during the mission. This could include spotlights, CUP processing time, images, cameras, the mission database, or anything else they might need. This gives us a lot of flexibility with the system. We're confident if something comes up during the operation wherein we need some additional functionality, we can make it happen in real short order.

Each vehicle in the system decides where it is going to work based on the knowledge of its own capabilities and the capabilities of other systems.

The Eagles not only work together to search the area but also to set up a canopy of radio communications over the area. This isn't just for date, the terrain makes it difficult for two-way communications to cover the entire area with out the help of a tower. Therefore, the Eagles act as radio towers as well. These communications are also digitized and streamed back through the LAN, thus the control center can communicate with the rescuers on the ground using 2-way radios.

The Eagles also employ Motorola's MEA mesh networking system. This allows 802.11 based PDA devices to get data from the network (images, coordinates, alarms/system alerts, etc). The Eagles while using their own proprietary communications protocol also supports TCP/IP for interoperability with other devices such as WindowsCE based handheld computers. That way we can direct rescuers to various positions as needed and they can go and investigate the possible clues found by the UAV's.

These systems can be operated with a PDA if necessary. We also have a trailer that has large HDTV plasma screens mounted on the walls so we can drive wherever we need to be. It just happened to work out that we don't need any of these and for this mission we're in the comfort of a nice roomy building.

Eagle 2 has position himself a high and over the western half of the search area. Eagle 3 has done the same over the eastern half. Both Eagles 2 & 3 have decided to run random patterns over their respective halves collection FLIR images and scanning those images for possible hits. Eagle 4 on the other hand is running regular square patterns at a fairly low altitude on the edges of tree lines and in the open areas of the Mesa. It doesn't have a very powerful FLIR camera. It doesn't have any zoom capability and so the closer the better.

Chopper 1 is heading to the area where the victims were last seen photographing along the way with its hi-resolution FLIR camera. Chopper 2 is also examining the tree lines and other tight areas not accessible with the Eagle platforms. They are all gathering and processing their own images. This lightens the network load as only the results of the processed frames are needed to go out over the network for mapping purposes. If that particular frame is needed for viewing, then it is recalled from the vehicle at that point. This allows more bandwidth for real-time viewing. Besides, the 80 GB laptop sized hard disks on the Choppers and Eagles are more than enough storage. Since we can, we might as well distribute the load.

The moon is out and so there is enough light for our visual cameras without a spot light. All the video feeds are coming through on our data link crystal clear. They fill the HDTV monitors that line the walls. The Sheriff and his assistants still can't get over the clarity of the images. They are much better than the noisy VHF NTSC broadcasts they've seen.

They are able to pan and zoom the cameras if they need and can instantly ‘rewind’ scenes to review things they think they missed.

The map of the search area on the wall begins to fill with green as areas are covered. Little flashing red dots begins to appear, as the vehicles pick up what they see are possible hits. Chopper 1 with the $20,000 FLIR hi-res camera is checking out each of these and taking the processing hi res pictures of these areas. It then compares those images against the signature templates (both visual and infrared) and rates them. The control station is constantly being updated with new information. Rescue workers both at the base camp up on the Mesa and here in the control room pure over these lists and examine images that have high probabilities.

Systematically and meticulously, the area is being scanned and information is being recorded and reviewed. Who knows, we might get lucky and the crafts themselves will find these people. If not, no big deal, someone will be reviewing the images shortly. Every video frame is being timed stamped, rated with a probability number, and then recorded and so we can review every frame later if we don't get a hit this time around.

9:00 pm—Tim reminds me that the heli's only have two hours of fuel on board in their standard configuration. One of the Sheriffs deputies overhears this and he makes a call on the radio:
“Melanie, this is Officer Anderson, we need a refueling pad setup for ARI's choppers in about 20 minutes. Put the marker on the pad when it's set up.”

She replies that it's already done, and they have the fuel cans ready. That training session we did with them has really made our jobs easier. They seem very comfortable with the system.

9:20 Chopper 1 & Chopper 2 have acknowledge the fueling spot marker. If they hadn't, they would have already been on their way back to the office by now. Both Chopper 1 and Chopper 2 head over to the refueling area. As they approach, both Ron and I take semi-manual control of the vehicles and direct them to where they are to land. They could do it on their own, but seeing as there are a lot of people milling around, we want to make sure they don't accidentally fly over people. This is forbidden in our system. Therefore, we direct the vehicles around the back of the camp and then a bee-line to the landing pads.

Once over the pad, just tell them to set down on their own. They descend, land and their engines shut off. The rotor brake is applied and once the rotors stop spinning, they shut off their navigation and strobe lights. This indicates to the folks doing the refueling that it is safe to approach the craft.

Refueling takes all of 5 minutes. A quick swivel of the video camera confirms that the lid is back on the gas tank and that everyone has cleared the area. I open the vehicles mike in the control station and say ‘Clear!’. This announcement is sent through the crafts on board speaker. One of the rescue volunteers sipping coffee near by almost burns himself. He's never heard a small helicopter talk before. The pad looks clear, so the start sequence begins. Strobe, nav and landing lights on, rotor brake on, the startup alarm sounds, lean the mixture (we're over 10,000 feet MSL), and engine start. It comes to life. Rotor brake off, mixture on auto, semi-manual control is on. Take off power is applied and the rotors spin up. I instruct Chopper 1 to climb to 500 feet AGL and then I direct it slowly away from (not over) their base camp.

As I'm moving away from the base camp Chopper 1 freezes. I can move it back the direction I came, but not the direction I want it to go. This whole time Chopper 1 has been talking to Chopper 2, getting its positional information. Chopper 1 was on the edge of violating Choppers 2's airspace, so it stopped.

I waited for Chopper 2 to clear the area and then I set Chopper 1 free. As soon as Chopper 1 had come to life after getting more fuel, it immediately queried the network for a list of images that had been flagged as being possibilities. By the time it was 500 AGL, it already had planned where it was going to go and what it was going to do.

9:30 pm—Data was coming in very rapidly now, people were busy pouring over previous FLIR video looking for indications. Some requested certain spots be re-checked. Some were rechecked by air (high power spot light and visual hi-res camera focused in on it) and to some a snowmobile was sent.

10:10 pm—Eagle 4 got a hit. The image processing software had given an image 60% probability that it had found what it thought were two people very close together inside a clump of trees, there was a third signature. Chopper 1 got wind of the news and started into that direction. Eagle 4 in the meantime released its Hummingbird, and it moved in to the last known position of the target.

Back in the control room, a red dot on the map began to flash. Chopper 1 was already en-route to the site to see if it could get any closer. It had established communication with the Hummingbird and we were starting to get video of the scene.

The Hummingbird made its way into the trees. It only had a visual camera and its LED search light didn't have that long of a range. That's ok; this vehicle's rotors are enclosed so it can afford to get close to solid objects without fear of being destroyed.

All of a sudden, the craft pitches vertical, I quickly take manual control and apply full power and attempt to bring the front of the craft level. I'm successful and the craft shoots upwards about 50 feet. I swing the nose around and to our relief and amusement see the family's blue heeler barking up a storm at us. Close by were two people, one was trying to maintain control of the dog. The information was quickly marked as a 100% hit. 20 PDA's simultaneously acquired the coordinates and begin vibrating and making loud noises . . . snowmobiles begin to converge on the site.

As Chopper 1 got closer, they moved out into the open, their dog bounced out of the trees barking like mad at the approaching helicopter. It's LED spot light was beaming just as bright as it could and its tracking system was working perfectly keeping the light fixed on the two women as they emerged from the forest waving their hands.

One of the first rescuers on the scene was seeing wrapping blankets around the women and giving them something hot from a thermos. Chopper 2 arrived and added additional overhead light on the scene as well as Eagle 4's lighting. The rescuer spoke with them for a minute more, picked up his radio, looked directly at the hovering Chopper 1, and started talking into his radio. The radio in the control room crackled to life.

“There is still one missing. She was talking to him on their walkie-talkie 10 minutes ago. She said he was having a hard time staying upright and that he was moving towards what he thought were headlights. She hasn't been able to rain him since.”

“Roger, we looking. I'm going to place the Hummingbird on the back of your snowmobile, would you make sure it makes it to base camp?”

“You bet.”

The Hummingbirds only have 20 minutes of flight time. It wasn't going to do us any more good out here. The winds were strong and it would use up most of its power just trying to move from one point to another. It was fine in the trees as they provided a bit of a barrier, but it was still working hard enough. I landed the Hummingbird on the back of his snowmobile. Other snowmobiles had arrived to bring Debra and Camille back to the base camp and to safety.

We directed Eagle 4 to follow them. It locked onto the machines as its target and began to follow. In addition, Eagle 4 and 3 had already change places in regards to low level searching, as Eagle 4 no longer had a Hummingbird attached. The Eagle's directional RF scanner logs were already being checked at this point for events during that time period. We find what we are looking for, but the source of the signal as back towards where we found the women. We play back the audio from those transmissions, and sure enough, the voice of Mr. Walker is loud and clear. But the direction of the source of his signal was not identified in time. It should have been, there was enough time . . . we're going to have to fix that.

They were using low-end consumer walkie-talkies and we knew that in this terrain, they couldn't go for more than one or two miles at best. The search area was re-drawn around where we thought the maximum radius of the radio signal could have propagated. We also marked areas that had steep banks and gave them priority. We knew we were racing against the clock. The room became increasingly tense as it was urgent to find him and soon. If he is trapped in a deep snow bank, he could suffocate faster than he would freeze.

Eagle 2 repositioned itself in the now smaller search area. Eagle 4 was following the rescuers back to base camp. After they arrive, it would take on another area of the search map. It would continue to fly high enough o keep the base camp connected with the rest of the network.

We continued to review the logs and found one radio transmission that had a direction away from where we found the women. We gave that sector priority as well. The vehicles reconfigure their route planning accordingly. We also gave a snowbound heat signature additional priority. When we did this, a number of red dots begin flashing.

Close inspection of each one commenced. Chopper 1 would take the lead with the highest priority finds. Chopper 2 worked with the rest. If it found reason to increase the priority of the target, it would do so. This would cause Chopper 1 to want to inspect it sooner.

Chopper 1 would get close into the spot first and capture images from several different points with its FLIR camera. Then it would activate its external infrared LED spot light and take more FLIR frames. Then it would move on to the next. It averaged 30 seconds at a single spot and averaged 30-second flying time to the next. Nothing on the ground can keep up with it.

We were getting both FLIR and crystal clear hi-res visual information to review. If needed, Chopper 1 would ask a nearby Eagle to pan it's spot light on the area to try to get the contrast a bit higher and any interesting images a bit sharper. When Chopper 1 got good FLIR footage, then Eagle 4 would come in, light up the area, and get hi res stills shots of it. It would also scan the area visually for signs of tracks or other disturbances in the snow. We found that if we played with the intensity of the light and used the NearIR capabilities of the visual camera we could get better contrast and se marks in the snow.

We eliminated on sighting after another and another. They were animals mostly, rabbits or coyotes. The wind was blowing pretty stiffly; the animal tracks were covered quickly. We knew we wouldn't be finding ski tracks. The search continued.

10:55 pm—Ron shouted excitedly. A hot spot had been found, and there were some extra disturbances in the snow pack that had not been covered up by the wind. The image and location was immediately broadcast to all the PDA's being used in the area. Also a voice announcement was made on the 2-way system. Eagle 2 from its vantage point showed a dozen or so snowmobile lights turn and head towards the site. The hit is marked as 100% certain, it can always be undone if it wasn't. All the remaining vehicles (except Eagle 1 and Eagle 4) converge on the scene.

Chopper 2 arrives with Chopper 1, Eagle 2 and 3. All three keep their required distanced from each other. They all blast IR and visible light on the point of the heat signature. The snow was deep and the digging frantic.

THERE: one arm, then two, Dan Walker was lifted out of the spot that was almost his grave. Back at the base camp Debra and Camille were wrapped in blankets watching the overhead scenes, hugging each other for joy. The weather was still too bad for the St. Mary's Helicopter to come. Dan was loaded up on a snowmobile and brought to a waiting ambulance. He's going to be okay, cold, a bit of frost bite, but okay. The snow was 10 feet deep there and he had fallen and had dunk deep into a drift.

Chopper 1 & 2 are really low on fuel. They head back to the base camp to be refueled. The used Hummingbird is attached to Chopper 2. The Eagles are fine. They loiter in the area to maintain contact with the Choppers. Once they refuel and are back in the air they all head back towards home.

There aren't many dry eyes in the control room, and there is a lot of celebration. It's hard to describe the feeling. It was a close one.

It's after 10 pm and Grand Junction Tower is closed. Ron brings the vehicles in the same way they left, making general traffic announcements on the CTAF frequency. The vehicles make their approach, Chopper 1 & 2 come in first and land. Eagles make a nice approach onto the runway, in formation touching down about the same time. They taxi on their own into the hanger. The door is closed and our post-flight inspection begins.

Ron makes a call to Flight Service and Denver Center to cancel the flight and NOTAM.

During the mission, Chopper 1 lost a flight control and an image-processing computer. We knew about this, but didn't pay much attention as it has 5 computers, three of which have inertial navigation systems. We have three flight control systems on board for this very reason. Because of the networking architecture, it was never really a concern. All three also contain the hardware for the flight control surfaces. The other two computers were for image processing.

When it lost an image-processing computer, Chopper 1 just restarted its image processing program on a node on one of the Eagles and sent the images to that process for work. The other two flight control computers were more than enough to handle the flight planning and stability requirements of the helicopter. It looks like it got some snow in there somehow and it melted and cause havoc on those CPUs.

We performed repairs, the machines were cleaned up, dried off, and a self-test was run. Fuel tanks were topped off and ail residue from the exhaust was cleaned. The systems were plugged into their DC power supplies and the process of off loading the recorded video was started. When it is done, they will shut themselves off.

12:15—I walked Sheriff Hilkey to the door. He shakes his head . . . .

“Kevin, we would have been up there for day if it wasn't for your system. Weather is forecast to get worse, aerial coverage using St. Mary's heli or the National Guard's is out of the question except for maybe ferrying people up and back from the site. Besides, even if we could use it, there is no way we could have covered the area you did tonight in the time that you did with your machines . . . .”

He pauses, I thought law enforcement hardened a person, I guess I was wrong . . . with a bit of emotion of his face he continued,

“. . . and . . . we would have been planning a memorial service for Dan. I doubt we would have been able to properly burry him until the spring.”

Stan opens the door, a blast of cold air hits me in the face, I shivered. I had forgotten how cold it was out side. Stan said good night and disappeared into the darkness.

Thus there has been described an aerial and ground robotic system that that is flexible and can be used for a variety of missions. Making this system less expensive to acquire, upgrade and maintain than present system.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An aerial and ground robotic system, comprising:
a plurality of mobile nodes creating a mesh network, including at least one aerial node;
a sensor on the at least one aerial node; and
a base station receiving data from the sensor through the mesh network.

2. The system of claim 1, wherein each of the mobile nodes has a transparent networking substrate for communication.

3. The system of claim 2, wherein each of the mobile nodes has a real time operating system.

4. The system of claim 1, wherein the base station has a mission planning software that allocates the plurality of mobile nodes geographically.

5. The system of claim 4, wherein the base station has a behavioral software that adjust a position of one of the plurality of mobile nodes based on a mission requirement.

6. The system of claim 1, wherein the at least one aerial node includes an operational vehicle stability software.

7. The system of claim 6, wherein the operational vehicle stability software includes a manual control option that allows an operator at the base station to manually fly the at least one aerial node.

8. An aerial and ground robotic system, comprising:
a robot having a sensor;
a plurality of mobile nodes forming a mesh network; and
a base station receiving data from the sensor through the network.

9. The system of claim 8, wherein the robot is an unmanned aerial vehicle.

10. The system of claim 8, wherein the robot is a ground based vehicle.

11. The system of claim 8, wherein each of the plurality of mobile nodes has a transparent networking substrate for communication.

12. The system of claim 11, wherein each of the mobile/nodes has a real time operating system.

13. The system of claim 12, wherein one of the mobile nodes is a handheld radio.

14. The system of claim 11, wherein the base station has a mission planning software that allocates the plurality of mobile nodes geographically.

15. An aerial and ground robotic system, comprising:
a base station;
a mobile mesh network having an aerial node; and
a robot having a sensor in communication with the base station through the mobile mesh network.

16. The system of claim 15, wherein a node of the mesh network is a hand held radio.

17. The system of claim 16, wherein the mesh network has a plurality of communication links and at least two of the communication links use a different communication protocol.

18. The system of claim 17, wherein the base station has a mission planning software.

19. The system of claim 18, wherein each node of the mesh network has a real time operating system.

20. The system of claim 19, wherein each node of the mesh network has a transparent networking substrate.
